(19) United States
(12) Patent Application Publication
(10) Pub. No.: US 2013/0167982 A1
(43) Pub. Date: Jul. 4, 2013

(54) METHOD FOR MANUFACTURING GRAIN ORIENTED ELECTRICAL STEEL SHEET

(71) Applicants: Hiroi Yamaguchi, Tokyo (JP); Seiji Okabe, Tokyo (JP); Kunihiro Senda, Tokyo (JP); Takeshi Omura, Tokyo (JP)

(72) Inventors: Hiroi Yamaguchi, Tokyo (JP); Seiji Okabe, Tokyo (JP); Kunihiro Senda, Tokyo (JP); Takeshi Omura, Tokyo (JP)

(73) Assignee: JFE STEEL CORPORATION, Tokyo (JP)

(21) Appl. No.: 13/806,877

(22) PCT Filed: Jun. 29, 2011
(86) PCT No.: PCT/JP2011/003724

§ 371 Date: Feb. 5, 2013

(30) Foreign Application Priority Data
Jun. 30, 2010 (JP) 2010-150152

(51) Int. Cl. H01F 41/22

(52) U.S. Cl. CPC H01F 41/22
USPC 148/525

(57) ABSTRACT

A method of manufacturing a grain oriented electrical steel sheet includes subjecting a steel slab to rolling to obtain a steel sheet, subjecting the steel sheet to decarburizing annealing, coating of an annealing separator mainly composed of MgO onto a surface of the steel sheet, and final annealing to obtain a grain oriented electrical steel sheet having at least 4.0 g/m² of coating weight of forsterite coating formed on the surface of the steel sheet, 0.9 μm or less of the average grain size of the forsterite coating, and at least 1.91 T of magnetic flux density B₈; and linearly irradiating a surface of the grain oriented electrical steel sheet this obtained with a laser having wavelength of 0.2 μm to 0.9 μm in a direction intersecting the rolling direction of the steel sheet.

### RELATED APPLICATIONS

This is a §371 of International Application No. PCT/JP2011/003724, with an international filing date of Jun. 29, 2011 (WO 2012/001971 A1, published Jan. 5, 2012), which is based on Japanese Patent Application No. 2010-150152, filed Jun. 30, 2010, the subject matter of which is incorporated herein by reference.

### TECHNICAL FIELD

This disclosure relates to a method for manufacturing a grain oriented electrical steel sheet having low iron loss suitable for an iron core material of a transformer or the like.

### BACKGROUND

A grain oriented electrical steel sheet is mainly utilized as an iron core of a transformer and required to exhibit excellent magnetization characteristics, e.g., low iron loss in particular.

In this regard, it is important to highly accumulate secondary recrystallized grains of a steel sheet in (110)[001] orientation, i.e., what is called “Goss orientation,” and reduce impurities in a product steel sheet.

However, there are limits on controlling crystal grain orientations and reducing impurities. Accordingly, there has been developed a technique of introducing non-uniformity into a surface of a steel sheet by physical means to subdivide the width of a magnetic domain to reduce iron loss, i.e., magnetic domain refining technique.

For example. JP-B 57-002252 proposes a technique of irradiating a steel sheet as a finished product with a laser to introduce linear high-dislocation density regions into a surface layer of the steel sheet, thereby narrowing magnetic domain widths and reducing iron loss of the steel sheet.

The magnetic domain refining technique using laser irradiation of JP '252 was improved thereafter (see JP-A 2006-117964, JP-A 10-204533, JP-A 11-779645 and the like) so that a grain oriented electrical steel sheet having good iron loss properties can be obtained.

There is, however, a demand for further improvement of iron loss properties of a gram oriented electrical steel sheet due to increasing public awareness of energy-saving and environment protection in recent years.

It could therefore be helpful to provide a method for manufacturing a grain oriented electrical steel sheet, which method enables effectively reducing iron loss through improvement of the magnetic domain refining technique by laser irradiation.

### SUMMARY

We thus provide:
[1] A method for manufacturing a grain oriented electrical steel sheet, comprising the steps of subjecting a steel slab for a grain oriented electrical steel sheet to rolling to obtain a steel sheet, subjecting the steel sheet to decarburizing annealing, coating of annealing separator mainly composed of MgO onto a surface of the steel sheet, and final annealing to obtain a grain oriented electrical steel sheet having at least 4.0 g/m² of coating weight of forsterite coating formed on the surface of the steel sheet, 0.9 μm or less of the average grain size of the forsterite coating, and at least 1.91 T of magnetic flux density B₈; and linearly irradiating a surface of the grain oriented electrical steel sheet thus obtained with a laser having wavelength in the range of 0.2 μm to 0.9 μm in a direction intersecting the rolling direction of the steel sheet.
[2] The method for manufacturing a grain oriented electrical steel sheet of [1] above, farther comprising micrifying the average grain size (i.e., setting 0.9 μm or less of the average grain size) of the forsterite coating by at least one of: increasing heating rate during heating process of the final annealing; decreasing an amount of Ti oxide to be added as an auxiliary agent to the annealing separator; and adding Al oxide to the annealing separator.
[3] The method for manufacturing a grain oriented electrical steel sheet of [1] or [2] above, further comprising providing the forsterite coating formed on the surface of the steel sheet with tension coating after the final annealing.
[4] The method for manufacturing a grain oriented electrical steel sheet of [1] or [2] above, further comprising subjecting the slab for a grain oriented electrical steel sheet to hot rolling, optionally hot-band annealing, and either one cold rolling operation or at least two cold rolling operations with intermediate annealing therebetween to obtain a cold rolled steel sheet.
[5] The method for manufacturing a grain oriented electrical steel sheet of [3] above, further comprising subjecting the slab for a grain oriented electrical steel sheet to hot rolling, optionally hot-band annealing, and either one cold rolling operation or at least two cold rolling operations with intermediate annealing therebetween to obtain a cold rolled steel sheet.

Iron loss of a grain oriented electrical steel sheet having forsterite coating thereon can be further reduced, as compared with the prior art, by subjecting a surface of the grain oriented electrical steel sheet to magnetic domain refining through laser beam irradiation under adequate conditions.

### DETAILED DESCRIPTION

In general, a surface of a grain oriented electrical steel sheet is covered with forsterite coating (coating mainly composed of Mg₂SiO₄) and tension coating thereon and the tension coating is subjected to laser irradiation. A steel sheet irradiated with a laser is imparted with thermal strain, whereby magnetic domains are each subdivided and iron loss is eventually reduced in the steel sheet.

Further, forsterite coating and tension coating each cause an effect of imparting a steel sheet with tensile stress. Characteristics of these coatings therefore may affect to some extent the iron-loss reducing effect caused by laser irradiation.

However, studies on the iron-loss reducing effect by laser irradiation in a steel sheet have conventionally been focused on how laser irradiation conditions should be changed, to reduce iron loss to the minimum, and influences of forsterite coating and tension coating on the iron-loss reducing effect have not been well investigated.

It is reasonably assumed that the higher tensile strength of forsterite coating of an electrical steel sheet results in the better iron-loss reducing effect when the electrical steel sheet is subjected to laser irradiation. Because, it has been revealed by observation that, when very strong thermal strain is introduced to a localized area of a steel sheet by laser irradiation to destroy the magnetic domain structure right under the locally irradiated portion, not only the magnetic domain structure right under the locally irradiated portion, but also magnetic domain structures in other adjacent areas of the locally irradiated portion are disturbed due to residual stress of the thermal strain and iron loss increases in these other areas. Accordingly, reducing these areas affected by the residual stress will decrease iron loss or enhance the iron-loss reducing effect. Furthermore, since the higher coating tensile strength the more effectively decreases these areas, characteristics of forsterite coating and laser irradiation conditions may interact each other in this connection.

Examples of techniques of introducing thermal strain to a surface of a steel sheet include plasma jet irradiation and electron beam irradiation, other than laser irradiation. Laser irradiation, as compared to the other examples, experiences reflection of beam at a coating surface. It is therefore important in laser irradiation to achieve efficient absorption of incident energy in view of the coating characteristics to obtain the maximum magnetic domain refining effect.

Based on the findings described above, we addressed the coating characteristics of forsterite coating and irradiation conditions of laser beam which allow incident energy of laser beam to be efficiently absorbed, and discovered that the aforementioned is advantageously achieved as desired by adequately adjusting the coating weight and average grain, size of the forsterite coating of a steel sheet and then irradiating the steel sheet with a laser beam having a specific wavelength range.

Our methods will be described in detail hereinafter.

When conditions of laser beam irradiation are considered in terms of achieving efficient absorption of incident energy, the first idea coming across one's mind would probably be making the wavelength of the laser beam shorter than the conventional length because a shorter wavelength has higher energy. However, a laser beam shifted toward a shorter wavelength may destroy the forsterite coating due to an excess increase in energy.

Therefore, we considered the relationship between adequate wavelength and coating strength of forsterite coating required in connection with the adequate wavelength on the premise that the laser beam is to be shifted toward shorter wavelength.

### Coating Characteristics of Forsterite Coating

The size of grains in forsterite coating is inversely proportional to the density of crystal grain boundaries. The smaller grain size therefore results in a higher coating strength, which causes an advantageous effect on iron-loss reduction. Further, the larger thickness of forsterite coating also results in a higher coating strength, which causes an advantageous effect on iron-loss reduction.

In view of this, we considered adequate crystal grain size and coating thickness of the forsterite coating. As a result, we discovered that the average crystal grain size of the forsterite coating is 0.9 μm or less and the thickness of the forsterite coating is at least 4.0 g/m² in coating weight.

Further, setting grain size and coating thickness of the forsterite coating to be the aforementioned specific ranges, respectively, is effective in terms of improving the absorption efficiency of the laser beam, as well as increasing the coating strength thereof. The forsterite coating, which is inherently transparent, looks white presumably because the laser beam is scattered at the grain boundaries and the like therein, in this regard, it is assumed that the relatively small average grain size of 0.9 μm or less and the resulting relatively high grain boundary density of the forsterite coating improve absorption of a laser beam therein. A similar effect is expected when the forsterite coating is relatively thick because the scattering rate increases in the forsterite coating.

The smaller average grain size of the forsterite coating is theoretically better. However, the average grain size of the forsterite coating is set appropriately in view of other requisite properties such as electromagnetic properties because the final annealing during which forsterite coating is formed affects other physical properties, as well. The average grain size of forsterite coating is preferably 0.6 μm or larger.

The average grain size of the forsterite coating can be determined by observing as coating surface by using a scanning electron microscope (SEM) or the like. Specific examples of determining the average grain size of the forsterite coating include: a method of dividing a field area by the number of grains and regarding the quotient as the area of a circle approximating each grain; and a method of drawing circles approximating respective grains through image processing and regarding the average of the diameters as the average grain size.

As a method for micrifying the average grain size of the forsterite coating, it is basically effective to suppress an oxidation reaction in the formation of forsterite coating in the finish annealing process at temperature around 1200° C. after coating of annealing separator mainly composed of MgO.

Specific examples of the method include:
(1) increasing the heating rate during the heating process of the final annealing (preferably to 15° C.-60° C./hour or so);
(2) decreasing an amount of Ti oxide to be added as an auxiliary agent to the annealing separator (preferably 1.2 parts by mass to 5.0 parts by mass, approximately with respect to 100 parts by mass of MgO); and
(3) adding Al oxide (preferably in the range of 0.001 mass % to 5 mass %, when converted into Al only mass) to the annealing separator.

The average grain size of the forsterite coating tends to decrease; as heating rate during heating process of the final annealing increases; and/or when an amount of Ti oxide to be added as an auxiliary agent to the annealing separator is reduced; and/or when Al oxide is added to the annealing separator. Specific preferred ranges of increase in heating rate during the heating process of the final annealing, decrease in an amount of Ti oxide added as an auxiliary agent to the annealing separator, and an amount of Al oxide added to the annealing separator vary depending on actual conditions in the manufacturing process. The average grain size of the forsterite coating can be controllably set to 0.9 μm or less by appropriately employing or combining at least one of the aforementioned three methods. In other words, the average grain size of the forsterite coating can be set to 0.9 μm or less by carrying out at least one of control of the heating rate during the heating process of the final annealing; control of an amount of Ti oxide added to the annealing separator; and an amount of Al oxide added to the annealing separator.

The annealing separator is mainly composed of MgO. This means that known annealing separator components and/or components for improving properties of annealing separator, other than the aforementioned MgO, Ti oxide and Al oxide, can be added to the annealing separator without causing any problem by amounts thereof which do not disturb formation of the forsterite coating. Contents of these optional components to be added to the annealing separator may be adjusted for the purpose of decreasing the average grain size of forsterite coating.

However, it is important that the measures to control the average grain size are combined with measures to increase the weight of oxide of the forsterite coating because the coating thickness of the forsterite coating needs to be at least 4.0 g/m².

Effective measures to increase the coating thickness of the forsterite coating to 4.0 g/m² or more include:
(a) increasing an amount of Si oxide such as fayalite (Fe₂SiO₄) formed in primary recrystallization annealing, which Si oxide is a material of forsterite (the amount of Si oxide, in terms of basis weight oxygen therein, is preferably at least 1.2 g/m² but 2.0 g/m² or less in view of avoiding too much load on the manufacturing process); and
(b) prolonging the retention time at the temperature in the surface oxide formation range in final annealing or decreasing the heating rate during the final annealing, to make the forsterite coating thick.

The coating thickness of the forsterite coating, however, is preferably 5.0 g/m² or less because the aforementioned measures to increase the coating thickness of the forsterite coating also increases load experienced during the manufacturing process.

### Conditions of Laser Beam Irradiation

The preferred wavelength of the laser beam is 0.2 μm to 0.9 μm in connection with the preferred crystal grain size and the preferred coating thickness of the forsterite coating described above. Suitable and advantageous examples of a laser oscillator having such a short wavelength as described above include, green lasers which are increasingly used in recent years.

The wavelength of the laser beam, 0.2 μm to 0.9 μm, is shorter than wavelengths of conventional YAG and CO₂ lasers and thus influences the insulating coating in a manner different from those conventional lasers. Specifically, an effect of reducing iron loss is well demonstrated for a steel sheet provided with a forsterite coating having an average grain size of 0.9 μm or less presumably because the short wavelength of 0.2 μm to 0.9 μm of the laser beam coincides with the specifically set range of grain size of the forsterite coating, whereby interaction between the laser beam and grains is amplified to significantly enhance absorption efficiency of the laser beam within the forsterite coating.

The lower limit of the wavelength of the laser beam is 0.2 μm in view of restrictions on manufacturing facilities.

The output of the laser is preferably 5 J/m to 100 J/m when expressed as a quantity of heat per unit length. The spot diameter of the laser beam is preferably 0.1 mm to 0.5 mm or so.

Further, an area where strain is introduced by the laser beam, of a steels sheet, preferably has a width: 30 μm to 300 μm, a depth of plastic strain: 3 μm to 60 μm, and repetition interval in the rolling direction: 1 mm to 20 mm.

The term “linear” configuration includes not only a solid line, but also a dotted line or a broken line.

Further, the term “direction intersecting the rolling direction” represents a direction within ±30° with respect to the direction orthogonal to the rolling direction.

The higher degree of accumulation of crystal grain orientation after secondary recrystallization in <100> orientation as the axis of easy magnetization results in the higher magnetic domain refining effect by laser processing. Therefore, the higher B₈ value as an index of the degree of accumulation of crystal grain orientation results in the higher iron-loss reducing effect by laser irradiation.

Therefore, the steel sheet is restricted to that having a magnetic flux density B₈ of 1.91 T or more.

A preferred method for manufacturing a grain oriented electrical steel sheet will be described hereinafter.

First, a preferred chemical composition of a material of the grain oriented electrical steel sheet will be described. The preferred chemical composition may be appropriately selected such that B₈ of at least 1.91 T is obtained based on chemical compositions of conventionally known, various grain oriented electrical steel sheets. It should be noted that compositions specifically described below are provided for exemplary purposes only.

When an inhibitor is used, the chemical composition of the material of the grain oriented electrical steel sheet may contain, for example, appropriate amounts of Al and N in a case where an AlN-based inhibitor is utilized or appropriate amounts of Mn and Se and/or S in a case where MnS.MnSe-based inhibitor is utilized. Both AlN-based inhibitor and MnS.MnSe-based inhibitor may be used in combination, of course. When inhibitors are used as described above, contents of Al, N, S and Se are preferably Al: 0.01 mass % to 0.065 mass %. N; 0.005 mass % to 0.012 mass %, S; 0.005 mass % to 0.03 mass %, and Se: 0.005 mass % to 0.03 mass %, respectively.

Our methods are also applicable to a grain oriented electrical steel sheet not using any inhibitor and having restricted Al, N, S, Se contents. In that ease, contents of Al, N, S and Se are preferably suppressed to Al: 100 mass ppm or less, N: 50 mass ppm or less, S: 50 mass ppm or less, and Se: 50 mass ppm or less, respectively.

Specific examples of basic components and other components to be optionally added of the grain oriented electrical steel sheet are as follows.

C: 0.08 mass % or less

Carbon content in steel is preferably 0.08 mass % or less because carbon content exceeding 0.08 mass % increases the burden of reducing carbon content during the manufacturing process to 50 mass ppm at which magnetic aging is reliably prevented. The lower limit of carbon content in steel need not be particularly set because secondary recrystallization is possible in a material not containing carbon.

Si: 2.0 mass % to 8.0 mass %

Silicon is an element which effectively increases electrical resistance of steel to improve iron loss properties thereof. A silicon content in steel equal to or higher than 2.0 mass % ensures a particularly good effect of reducing iron loss. On the other hand, Si content in steel equal to or lower than 8.0 mass % ensures particularly good formability and magnetic flux density of steel. Accordingly, Si content in steel is preferably 2.0 mass % to 8.0 mass %.

Mn: 0.005 mass % to 1.0 mass %

Manganese is an element, which, advantageously achieves good hot-formability of steel. Manganese content in steel less than 0.005 mass % cannot cause the good effect of Mn addition sufficiently. A manganese content in steel equal to or lower than 1.0 mass % ensures particularly good magnetic flux density of a product steel sheet. Accordingly, Mn content in steel is preferably 0.005 mass % to 1.0 mass %.

Further, the grain oriented electrical steel sheet may contain the following elements as magnetic properties improving components in addition to the basic components described, above.

At least one element selected from Ni: 0.03 mass % to 1.50 mass % Sn: 0.01 mass % to 1.50 mass %, Sb: 0.005 mass % to 1.50 mass %. Cu: 0.03 mass % to 3.0 mass %, P: 0.03 mass % to 0.50 mass %, Mo: 0.005 mass % to 0.10 mass %, and Cr: 0.03 mass % to 1.50 mass %

Nickel is a useful element in terms of further improving the microstructure of a hot rolled steel sheet and thus the magnetic properties of a resulting steel sheet. A nickel content in steel less than 0.03 mass % cannot cause this magnetic properties-improving effect by Ni sufficiently. A nickel content in steel equal to or lower than 1.5 mass % ensures stability in secondary recrystallization in particular to improve the magnetic properties of a resulting steel sheet. Accordingly. Ni content in steel is preferably 0.03 mass % to 1.5 mass %.

Sn, Sb, Cu, P, Cr and Mo are useful elements, respectively, in terms of further improving the magnetic properties of the steel sheet, Contents of these elements lower than the respective lower limits described above result in an insufficient magnetic properties-improving effect. Contents of these elements equal to or lower than the respective upper limits described above ensure the optimum growth of secondary recrystallized grains. Accordingly, it is preferable that steel contains at least one of Sn, Sb, Cu, P, Cr and Mo within the respective ranges thereof specified above.

The balance other than the aforementioned components of the steel sheet is preferably Fe and incidental impurities incidentally mixed into steel during the manufacturing process.

The conventional, known manufacturing; processes of a grain oriented electrical steel sheet can be basically applied to manufacturing processes of the grain oriented electrical steel sheet.

Either a slab may be produced by the conventional ingot/continuous casting method or a thin slab or a thinner cast steel having thickness of 100 mm or less may be produced by direct continuous casting, from a steel material having chemical composition adjusted as described above. The slab thus produced is heated and hot rolled according to the conventional method, but may optionally be hot rolled without being heated immediately after casting. The thin slab or the like may be either directly hot rolled or skip hot rolling to proceed to the subsequent processes. A steel sheet thus obtained is then preferably subjected to optional hot band annealing, either one cold rolling operation or at least two cold rolling operations with intermediate annealing therebetween to have the final sheet thickness, decarburizing annealing, coating of annealing separator mainly composed of MgO, final annealing, and optional provision of tension coating thereon in order, to be a finished product.

Applicable examples of the tension coating include known tension coatings such as glass coating mainly composed of a combination of phosphates like magnesium phosphate or aluminum phosphate and low-thermal expansion oxide like colloidal silica, and the like.

Various measures to control the average grain size of the forsterite coating, as well as various measures to adjust the coating thickness of the forsterite coating, are taken such that the coating weight and average grain size of the forsterite coating formed on a surface of the steel sheet during the aforementioned final annealing are at least 4.0 g/m² and 0.9 μm or less, respectively.

Further, the steel sheet is irradiated with a laser beam either after the final annealing or after the provision of tension coating and it is important in this connection that the wavelength of the laser beam is set to 0.2 μm to 0.9 μm during the laser irradiation as described above.

### EXAMPLES

A steel slab having a composition (a composition corresponding to an inhibitorless process) containing C: 0.03 mass %, Si: 3.25 mass %, Mn: 0.03 mass %, Al: 60 mass ppm, N: 40 mass ppm, S: 20 mass ppm, and the balance as Fe and incidental impurities was prepared by continuous casting. The steel slab was heated to 1400° C. and hot-rolled to obtain a hot rolled steel sheet having sheet thickness of 2.0 mm. The hot rolled steel sheet was then subjected to hot-band annealing at 1000° C. and two cold roiling operations with intermediate annealing therebetween to obtain a cold rolled steel sheet having the final sheet thickness of 0.23 mm. The cold rolled steel sheet was subjected to decarburizing annealing at 850° C. and a coating of annealing separator mainly composed of MgO. Regarding the annealing separator, an annealing separator mainly composed of MgO having purity of 95% and containing Al impurity was used as the primary annealing separator and the content of TiO₂ added to the primary annealing separator was changed in each samples. Next, the steel sheet was subjected to final annealing at 1200° C., for secondary recrystallization, formation of the forsterite coating and purification, and then tension coating treatment including coating and baking of the insulating coating composed of 50% colloidal silica and magnesium phosphate in order.

Thereafter, the steel sheets thus obtained were irradiated with a laser beam from various types of continuous-wave oscillation laser sources. Beam diameter was 0.2 mm and beam scanning rate was 300 mm/second. Laser output was changed in 5 W increments in the range of 5 W to 50 W to find out the optimum condition in terms of reducing iron loss.

The analysis results of coating weight, the average grain size of forsterite coating and magnetic properties (iron loss W_{17/50}, magnetic flux density B₈), of each of the steel sheet products thus obtained were shown in connection with wavelengths of laser beam applied thereto in Table 1,

TABLE 1

| | Forster [symbol] e coating | | Conditions of laser beam irradiation | | | Magnetic | | |
|---|---|---|---|---|---|---|---|---|
| | Coating | Average | | | Distance of | properties | | |
| | weight | grain size | Wavelength | Irradiation width | Irradiation interval | B₈ | W_{17/50} | |
| No. | (g/m²) | (μm) | (μm) | (μm) | (mm) | (T) | W/kg) | Note |
| 1 | 4.5 | 0.85 | 1.06 | 100 | 5 | 1.934 | 0.77 | Comp. Example |
| 2 | 4.0 | 0.95 | 1.06 | 100 | 5 | 1.930 | 0.78 | Comp. Example |
| 3 | 4.3 | 0.87 | 0.86 | 100 | 5 | 1.935 | 0.68 | Example |
| 4 | 3.7 | 0.85 | 0.86 | 100 | 5 | 1.934 | 0.76 | Comp. Example |
| 5 | 4.3 | 0.96 | 0.53 | 150 | 5 | 1.931 | 0.78 | Comp. Example |
| 6 | 4.1 | 0.86 | 0.53 | 150 | 5 | 1.931 | 0.70 | Example |
| 7 | 3.5 | 1.02 | 0.36 | 150 | 5 | 1.929 | 0.79 | Comp. Example |
| 8 | 4.1 | 0.86 | 0.36 | 150 | 7.5 | 1.908 | 0.83 | Comp. Example |
| 9 | 4.6 | 0.85 | 0.27 | 100 | 7.5 | 1.935 | 0.67 | Example |
| 10 | 4.3 | 0.99 | 0.27 | 100 | 7.5 | 1.931 | 0.78 | Comp. Example |

[symbol]

indicates data missing or illegible when filed

It is understood from Table 1 that the cases where electrical steel sheets provided with a forsterite coating having an average grain size of 0.9 μm or less and coating weight of at least 4 m g/m² were irradiated with a laser beam having wavelength in the range of 0.2 μm to 0.9 μm, i.e., our Examples, unanimously exhibited very low iron loss values.

Further, comparison of Sample No. 5 with Sample No. 6 reveals that iron loss is significantly reduced or iron loss properties significantly improve by setting the average grain size of forsterite to be 0.9 μm or less.

Yet further, comparison of Sample No. 4 with Sample No. 3 reveals that iron loss is significantly reduced or iron loss properties significantly improve by setting coating weight of forsterite to be 4.0 g/m² or more.

Still yet further, comparison of Sample No. 1 with Sample No. 3 reveals that iron loss is significantly reduced or iron loss properties significantly improve by setting wavelength of laser beam to be 0.9 μm or less.

It should be rioted that an electrical steel sheet having magnetic flux density B₈ less than 1.91 T failed to exhibit a satisfactory iron loss value, although the steel sheet was manufactured by our method.

### INDUSTRIAL APPLICABILITY

Iron loss of a grain oriented electrical steel sheet having forsterite coating thereon can be reduced, as compared with the prior art, by subjecting a surface of the grain oriented electrical steel sheet to magnetic domain refining through laser beam irradiation under adequate conditions.

1. A method of manufacturing a grain oriented electrical steel sheet comprising:
subjecting a steel slab to rolling to obtain a steel sheet, subjecting the steel sheet to decarburizing annealing, coating of an annealing separator mainly composed of MgO onto a suit ac of the steel sheet, and final annealing to obtain a grain oriented electrical steel sheet having at least 4.0 g/m² of coating weight of forsterite coating formed on the surface of the steel sheet, 0.9 μm or less of the average grain size of the forsterite coating, and at least 1.91 T of magnetic flux density B₈; and
linearly irradiating a surface of the grain oriented electrical steel sheet thus obtained with a laser having wavelength of 0.2 μm to 0.9 μm in a direction intersecting the rolling direction of the steel sheet.

2. The method of claim 1, further comprising micrifying the average grain size of the forsterite coating by at least one of: increasing heating rate during heating process of the final annealing; decreasing an amount of Ti oxide to be added as an auxiliary agent to the annealing separator; and adding Al oxide to the annealing separator.

3. The method of claim 1, further comprising providing the forsterite coating formed on the surface of the steel sheet with tension coating after the final annealing.

4. The method claim 1, further comprising subjecting the slab to hot rolling, optionally, hot-band annealing, and either one cold rolling operation or at least two cold rolling operations with intermediate annealing therebetween to obtain a cold roiled steel sheet.

5. The method of claim 3, further comprising subjecting the slab to hot roiling, optionally, hot-band annealing, and either one cold roiling operation or at least two cold rolling operations with intermediate annealing therebetween to obtain a cold roiled steel sheet.

6. The method of claim 2, further comprising providing the forsterite coating formed on the surface of the steel sheet with tension coating after the final annealing.

7. The method of claim 2, further comprising subjecting the slab to hot rolling, optionally, hot-band annealing, and either one cold rolling operation or at least two cold rolling operations with intermediate annealing therebetween to obtain a cold rolled steel sheet.

8. The method of claim 6, further comprising subjecting the slab to hot rolling, optionally, hot-band annealing, and either one cold rolling operation or at least two cold rolling operations with intermediate annealing therebetween to obtain a cold rolled steel sheet.
